(19) United States
(12) Patent Application Publication
(10) Pub. No.: US 2016/0253383 A1
(43) Pub. Date: Sep. 1, 2016

(54) MANAGEMENT-INFORMATION ACQUIRING PROGRAM, MANAGEMENT INFORMATION ACQUIRING METHOD, AND MANAGEMENT INFORMATION ACQUIRING APPARATUS

(71) Applicant: FUJITSU LIMITED, Kawasaki-shi (JP)

(72) Inventors: Kensuke Tokoda, Nagoya (JP); Kiyoshi KOUGE, Kuwana (JP); Takaaki Nakazawa, Nagoya (JP); Satoshi Ohta, Kitanagoya (JP); Yuki Torii, Anjo (JP); Yukihisa Miyagawa, Tsushima (JP); Satoshi Matsuda, Nagoya (JP); Kenichi Mori, Aisai (JP); Yoko Yonemoto, Nagoya (JP); Saeko Nakamura, Ichinomiya (JP); Takeshi Kawaguchi, Nagoya (JP); Ichiro Kotani, Nagoya (JP); Shinnosuke Nagakura, Yokohama (JP); HUI LI, Obu (JP); Naoki Tateishi, Nagoya (JP); Kazunori Kandani, Nagoya (JP)

(73) Assignee: FUJITSU LIMITED, Kawasaki-shi (JP)

(21) Appl. No.: 15/049,685

(22) Filed: Feb. 22, 2016

(30) Foreign Application Priority Data
Feb. 27, 2015 (JP) 2015-037667

(51) Int. Cl. G06F 17/30

(52) U.S. Cl. CPC G06F 17/30466; G06F 17/30477

(57) ABSTRACT

A non-transitory computer-readable storage medium storing therein a management-information acquiring program that causes a computer to execute a process includes acquiring queries to a target database for a management target service system, specifying a reference target table in the database based on names of target tables included in the queries and content of the queries, specifying a reporting target table on the basis of data of the reference target table, causing the database to execute an acquisition query to the reporting target table, and acquiring specific management information from the reporting target table.

### CROSS-REFERENCE TO RELATED APPLICATION

This application is based upon and claims the benefit of priority of the prior Japanese Patent Application No. 2015-037667, filed on Feb. 27, 2015, the entire contents of which are incorporated herein by reference.

### FIELD

The present invention relates to a management-information acquiring program, a management information acquiring method, and a management information acquiring apparatus.

### BACKGROUND

A service system provides a large number of users with a predetermined service in Web sites of the Internet or an intranet. In such a service system, an information processing apparatus (hereinafter simply referred to as server) executes an application program of a service (hereinafter referred to as service application) and an application program of a Web service for performing access processing and the like between user terminals and the server (hereinafter referred to as Web application).

The performance of the Web application is one of factors for improving service quality of the service system. Therefore, checking and improving various kinds of performance lead to the improvement of the service quality of the service system.

Examples of the various kinds of performance of the Web application include response speed to accesses, resistance of the server against access concentration for preventing hang-up in case of concentration of accesses (a degree not causing server down). Low response speed and low resistance of the server against access concentration cause deterioration in the service quality.

On the other hand, according to the spread of a cloud computing service (hereinafter simply referred to as cloud service), computer infrastructures have been able to be used inexpensively and easily. Accordingly, a service system is constructed using the infrastructures of the cloud service. The service system sometimes uses a Web application provided in the cloud service. Therefore, an operation administrator of the cloud service different from an operation administrator of the service system sometimes performs a performance analysis of the Web application and improves the performance of the Web application on the basis of a result of the analysis.

For the performance analysis of the Web application, for example, data of a database of the Web application needs to be referred to. For example, when response speed, which is one kind of the performance of the Web application, is low, priority order of response speed improvement is decided on the basis of the numbers of customers in countries, companies, or connection areas where the response speed is low. In that case, the number of customers for each of the countries, companies, or the connection areas needs to be acquired from the database.

Therefore, a query for extracting necessary data from the database is created. The database is caused to execute the query to extract the necessary data. Such a technique is described in Japanese Patent Application Laid-open No. H11-003257, Japanese Patent Application Laid-open No. H08-137810, Japanese Patent Application Laid-open No. 2011-221861, and Japanese Patent Application Laid-open No. 2012-014267.

### SUMMARY

However, an operation management server of the cloud service that collects and manages the performance of the Web application is different from the server that provides the service system. The operation administrator of the cloud service may be sometimes unable to acquire the configuration of the database of the service system. In general, the operation administrator is not permitted to acquire raw data of the database.

One aspect of the disclosure is a non-transitory computer-readable storage medium storing therein a management-information acquiring program that causes a computer to execute a process includes acquiring queries to a target database for a management target service system, specifying a reference target table in the database based on names of target tables included in the queries and content of the queries, specifying a reporting target table on the basis of data of the reference target table, causing the database to execute an acquisition query to the reporting target table, and acquiring specific management information from the reporting target table.

According to the first aspect of the embodiment, it is possible to extract necessary data from the database.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining response performance of the service system;

FIG. 2 is a diagram depicting an example of a response performance table in which the response performance is collected;

FIG. 3 is a diagram depicting a relation example between the management server and service systems;

FIG. 4 is a diagram depicting a configuration example of a management server and a service system in a first embodiment;

FIG. 5 is a diagram depicting another configuration example of the service system and the management server in the first embodiment;

FIG. 6 is a diagram depicting the configuration of the physical machines 1, 2, and 3 and the management server 34 depicted in FIG. 5;

FIG. 7 is a flowchart for explaining processing of a management-information acquiring program in the first embodiment;

FIG. 8 is a diagram depicting a configuration information of a management server and a service system in the second embodiment;

FIG. 9 is a flowchart for explaining schematic processing of the priority-information acquiring agent 37 in the second embodiment;

FIG. 10 is a flowchart of processing by the performance-improvement-analysis-information generating unit 342 of the management server;

FIG. 11 is a detailed flowchart of the collecting step S20 for query information;

FIG. 12 is a detailed flowchart of the specifying processing S22 for the master data table;

FIG. 13 is a detailed flowchart of the specifying processing S23 for the user table by the table analyzing unit;

FIG. 14 is a detailed flowchart of the specifying processing S24 for the country data table by the table analyzing unit;

FIG. 15 is a detailed flowchart of the number-of-users-by-country acquisition query creation S26 by the acquisition-query creating unit;

FIG. 16 is a flowchart of a joining information search function;

FIG. 17 is a diagram depicting an example in which the user table and the country code table has a relation via other tables;

FIG. 18 is a detailed flowchart of the number-of-users-by-country acquisition processing S28, which is priority information by the priority-information acquiring unit 374;

FIG. 19 is a detailed flowchart of the generation processing S29 for the performance-improvement-analysis-information database;

FIG. 20 is a diagram depicting an example of a user table “user” and an account table “account” included in the job database;

FIG. 21 is a diagram depicting an example of a country data table “country” and a role table “role” included in the job database;

FIG. 22 is a diagram depicting an example of a sales data table “sales”, an order table “order”, and a product table “product” included in the job database;

FIG. 23 is a diagram depicting an example of a response performance table in the performance information database 343 stored by the management server 34;

FIG. 24 is a diagram depicting an example of the query information table 375_1;

FIG. 25 is a diagram depicting an example of the table analysis information table;

FIG. 26 is a diagram depicting an example of a number-of-users-by-country-information acquisition query in the second embodiment;

FIG. 27 is a diagram depicting an example of the number-of-users-by-country information table including the number of users by country acquired by the acquisition query;

FIG. 28 is a diagram depicting arithmetic processing of the query in the fourth row of FIG. 24; and

FIG. 29 is a diagram depicting an example of the performance improvement analysis information table.

### DESCRIPTION OF EMBODIMENTS

In an embodiment of the present invention, a management target service system is explained with reference to, as an example, a service system in which a server (a Web server) that provides Web sites with a Web service is provided. The service system is accessed from a plurality of users in the world via the Internet and intranets and provides a predetermined service. The performance of a Web application of the Web server is, for example, response speed from an access to the Web server by a user terminal until reception of a response. Management information desired to be collected to improve the response speed is, for example, the number of users for each of countries, companies, or connection areas.

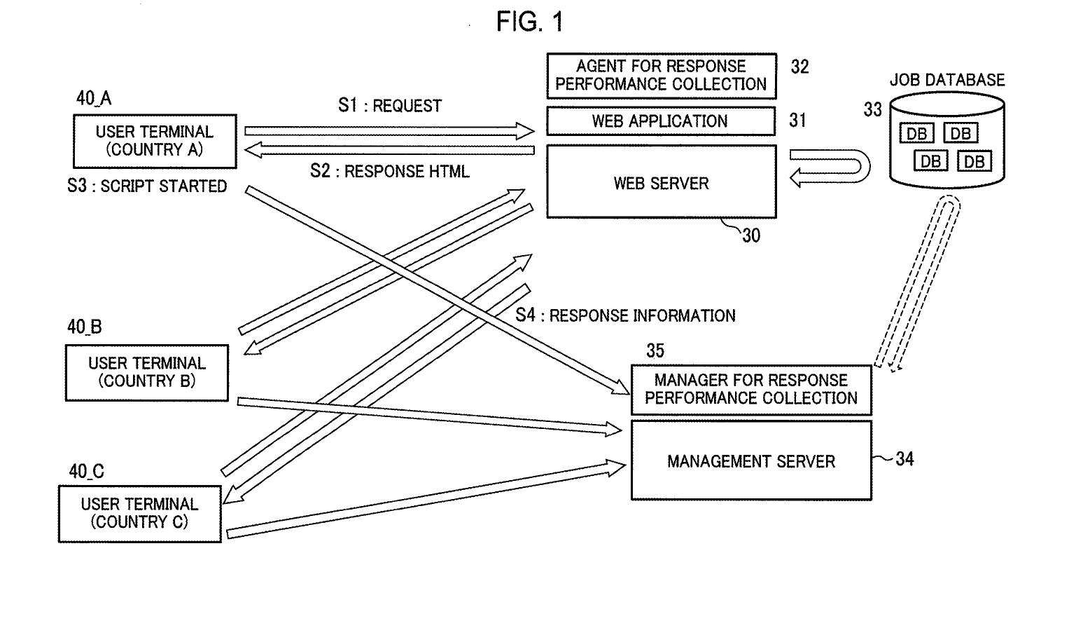

FIG. 1 is a diagram for explaining response performance of the service system. A Web server 30 executes a Web application 31 and provides a plurality of user terminals 40_A to 40_C in a plurality of countries with a predetermined Web service. The Web server 30 provides users with the Web service using a job database 33. The job database 33 includes, for example, master data tables such as a user table and a commodity data table and transaction data tables such as a purchase data table and a deposit/withdrawal data table.

On the other hand, a management server 34 collects response performance (response speed) of the Web application 31. Therefore, an agent (program) for response performance collection 32 is installed in the Web server 30. A manager (program) 35 for response performance collection is installed in the management server 34.

As illustrated in FIG. 1, the user terminal 40_A of a country A, the user terminal 40_B of a country B, and the terminal 40_C of a country C access the Web server 30 and transmit a predetermined request (S1). The Web server 30 executes the Web application 31 and returns a response to the request (S2). The response is usually a file described in an HTML language. Browsers of the user terminals 40 execute the HTML file to generate a response screen.

In order to measure the response speed, which is the response performance, an agent for response performance collection 32 of the Web server 30 embeds a script for measuring the response speed in the HTML file of the response. The browsers of the user terminals 40 start the script embedded in the HTML file of the response. The started script collects information concerning the response performance from the browser (S3) and transmits the information to the management server 34 (S4).

The management server 34 is managed by an operator of the cloud service. A manager for response performance collection 35 of a management server 34 collects the received response performance information. Consequently, the operator of the cloud service collects and monitors, with the manager for response performance collection 35 of the management server 34, information concerning the response performance (the response speed) experienced by users in the world with respect to the Web server 30.

When the response speed decreases in a plurality of countries, the operator of the cloud service needs to improve the response speed. However, since factors of the decrease in the response speed of the Web application are various factors such as a network route and a delay of an associated Web service, enormous workloads are needed for an investigation of a cause and improvement. Therefore, it is difficult to perform improvement of the response speed in all the plurality of countries at a time. In that case, when the response speed in the plurality of countries is low to the same degree, priority of performance improvement is determined on the basis of priority information for performance improvement.

As a candidate of the priority of the performance improvement, first, there is the number of requests. In a country where the number of requests is large, the influence of the decrease in the response speed is large. Therefore, it is possible to determine that the priority of the performance improvement is higher in a country where the number of requests is larger. In that case, the priority information can be acquired by tabulating the number of requests by country in the Web server.

However, when the same user issues a large number of requests, an improvement effect of the response speed appears only in a part of the users. Therefore, the number of requests by country is not appropriate as the priority of the performance improvement. Information for enabling identification of a user from a request (e.g., a user ID) is different for each application. Therefore, it is difficult to identify users of requests and also it is difficult to detect that a lot of requests are issued by the same user.

As the candidate of the priority of the performance improvement, second, there is the number of users by country. The influence of the decrease in the response speed is large in a country where the number of users is large. Therefore, it is possible to determine that the priority of the performance improvement is higher in a country where the number of users is larger. The operator of the cloud service can improve service quality for a large number of users by preferentially improving, according to this determination criterion, the response speed in the country where the priority is high.

However, as indicated by a broken line in FIG. 1, the management server 34 is sometimes not permitted to directly access the job database 33. The operator of the cloud service who manages the management server 34 may be unable to learn structure information of the job database 33. Therefore, it is not easy to access the job database 33 and acquires the number of users by country.

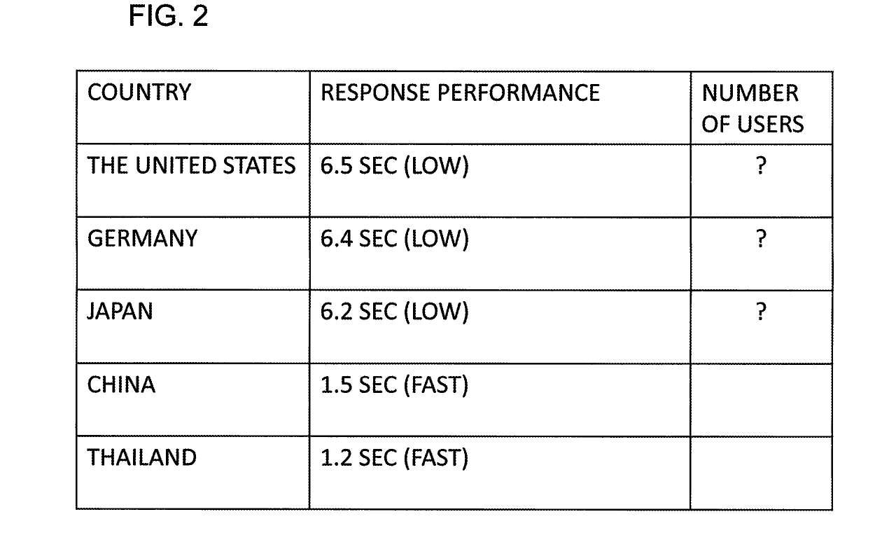

FIG. 2 is a diagram depicting an example of a response performance table in which the response performance is collected. According to the method explained with reference to FIG. 1, the management server 34 collects the response performance (the response speed) of each country as depicted in FIG. 2. In the example depicted in FIG. 2, it is found that the response speed is low in the same degree in the United States, Germany, and Japan. However, the number of users of each country, which is the priority of the performance improvement, may be unable to be acquired. Therefore, it may be unable to be determined in which country among the United States, Germany, and Japan the performance improvement is performed first.

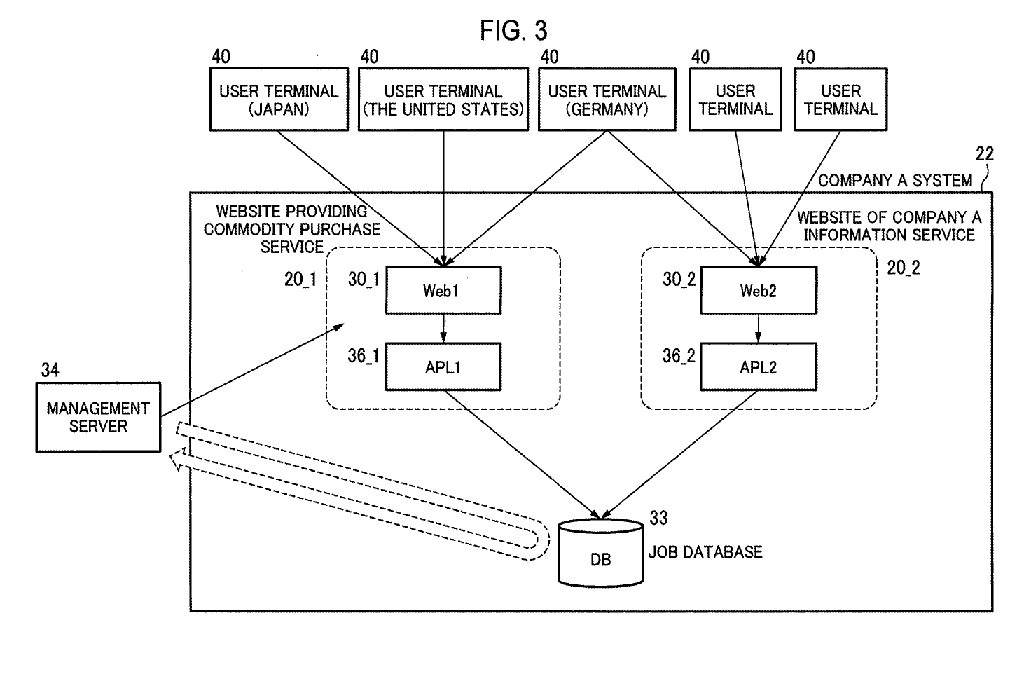

FIG. 3 is a diagram depicting a relation example between the management server and service systems. In the example depicted in FIG. 3, company A system 22 includes a service system 20_1 that provides a commodity purchase service and a service system 20_2 that provides a company A information service. The respective service systems 20_1 and 20_2 include Web servers 30_1 and 30_2 and application servers 36_1 and 36_2. The Web servers 30_1 and 30_2 are accessed from a plurality of user terminals 40, receive a predetermined request, and return responses to the request. The Web servers 30_1 and 30_2 issue queries to the job database 33 via the respective application servers 36_1 and 36_2 and acquire or register desired information. The acquired information is reflected on, for example, the responses.

On the other hand, the management server 34 is set in a network outside a network of the company A system. Therefore, as indicated by a broken line in FIG. 3, the management server 34 is sometimes not permitted to directly issue a query to the job database 33 and directly acquire desired information. Further, the management server 34 sometimes may be unable to acquire the structure information of the job database 33 beforehand. Therefore, it is not easy for the management server 34 to acquire desired information from the job database 33.

Therefore, when the management server 34 performs, as a management service, monitoring of the response performance of the Web server 30, the management server 34 can tabulate the response speed by country according to the mechanism explained with reference to FIG. 1. However, it is difficult to acquire the number of users by country from the job database 33 as the priority information.

Even if installation of an agent (program) for collecting priority information in the company A system 22 is permitted, under a situation in which the structure information of the job database may be unable to be acquired, it is difficult for the agent to acquire desired priority information from the job database 33. Further, the agent is not permitted to directly pass raw data of the job database 33 to the management server 34.

### First Embodiment

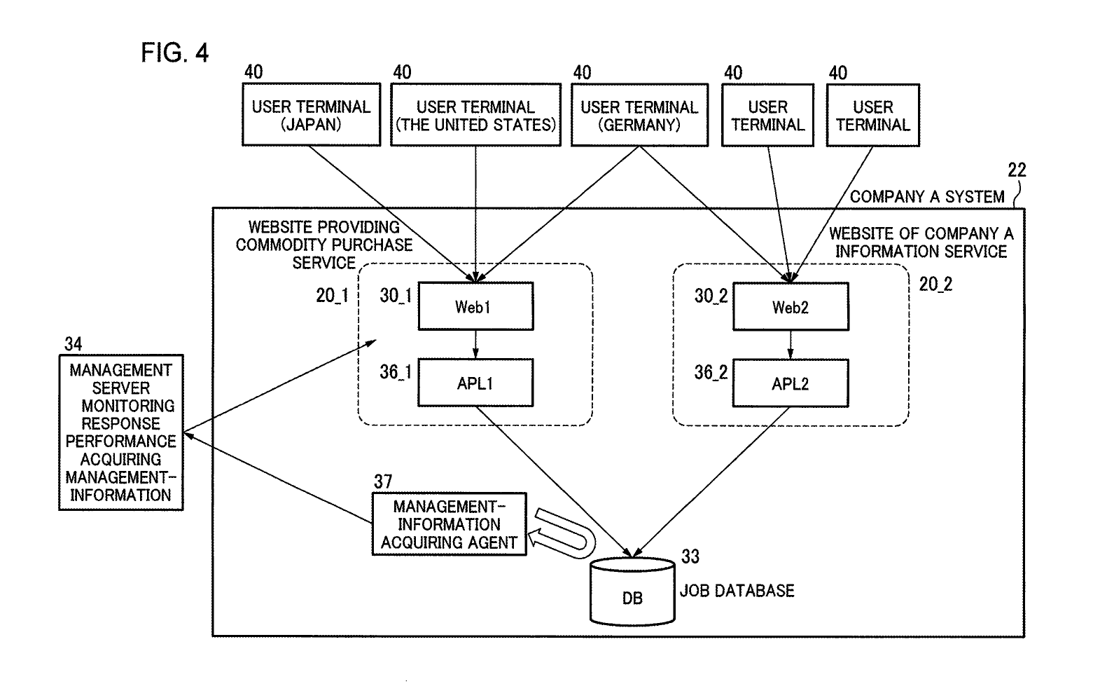

FIG. 4 is a diagram depicting a configuration example of a management server and a service system in a first embodiment. The configuration is different from the configuration depicted in FIG. 3 in that a management-information acquiring agent (program) 37 cooperating with the management server 34 is installed in the company A system 22. The management-information acquiring agent 37 analyzes a plurality of queries to the job database 33, specifies tables included in the job database 33, generates, on the basis of specified table information, an acquisition query for acquiring desired management information, and acquires the desired management information from the job database 33 according to the acquisition query. The management-information acquiring agent 37 provides the management server 34 with the acquired management information.

Consequently, the management server 34 can collect the response performance and collect the management information collected by the management-information acquiring agent 37 from the job database 33. The management information is, for example, performance improvement priority information, which is the number of users by country, explained in the example depicted in FIG. 1.

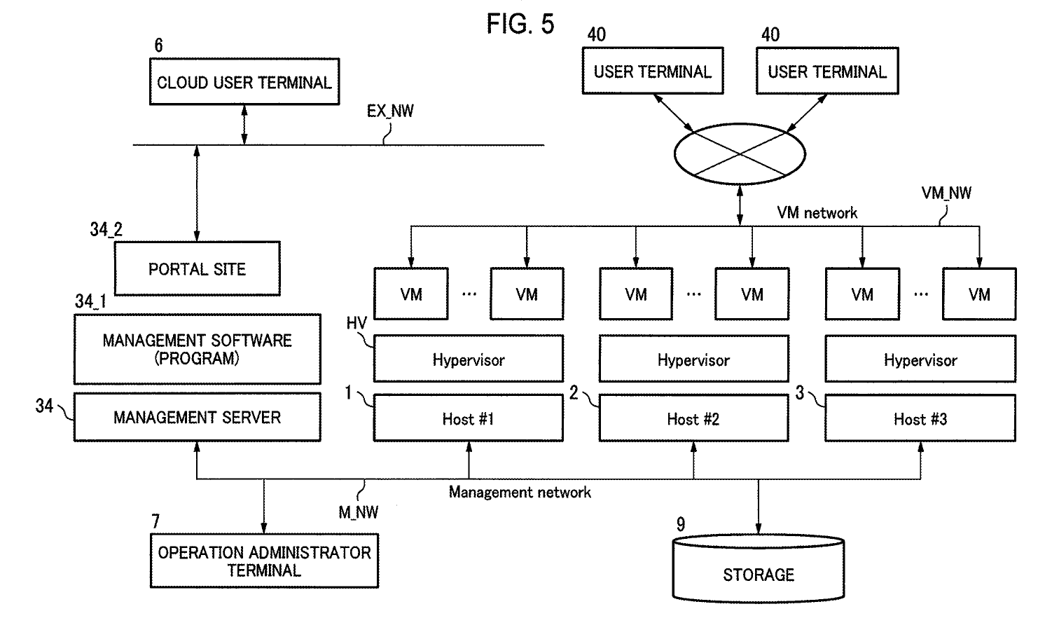

FIG. 5 is a diagram depicting another configuration example of the service system and the management server in the first embodiment. FIG. 5 depicts a server facility (or a data center). The server facility includes a plurality of physical machines (or VM hosts or host machines) 1, 2, and 3 that execute a plurality of virtual machines VM on a hypervisor HV, the management server 34 that manages the physical machines and the virtual machines, and a storage 9. The service system is constructed in the server facility in which a large number of physical machines are deployed. The server facility provides the users with hardware resources such as the physical machines to provide a cloud computing service.

The physical machines 1, 2, and 3 execute the hypervisor HV to create and execute the plurality of virtual machines VM. That is, the hypervisor HV creates and executes the virtual machines VM. The storage 9 stores an image file including a guest operating system (OS) of the virtual machines VM and application programs. The virtual machines VM expand, in memories of the physical machines 1, 2, and 3, the guest OS and the application programs of the image file stored in the storage 9, execute the guest OS and the application programs expanded in the memory, and construct a desired service system.

A management program 34_1 of the management server 34 causes the hypervisor HV to create a virtual machine based on configuration information, temporarily stop (pause) and resume the virtual machine according to necessity, and delete the virtual machine. The configuration information includes, for example, information concerning the numbers of CPU cores and memory capacities allocated to the virtual machines VM.

A Web server and application servers (not depicted in the figure) configuring the service system are configured by the virtual machines VM, a network VM_NW of virtual machines, and the storage 9. The Web server configured by the virtual machine VM is connectable to the user terminals 40 via the network VM_NW. The storage 9 stores, for example, information concerning a job database. A database server (not depicted in the figure) configured by the virtual machine VM constructs the job database in cooperation with the information concerning the job database in the storage 9.

In this embodiment, the management program 34_1 further includes a manager for response performance collection that collects response performance of the Web server of the service system configured by the virtual machine VM. The management program 34_1 includes an installation program for installing the management-information acquiring agent (program) in the service system and an analysis information generating program for causing the management-information acquiring agent (program) installed in the service system to acquire desired management information, receiving the management information, and generating desired analysis information, and so on. The management-information acquiring program is stored in, for example, the storage 9 depicted in FIG. 5 and executed by the database server in the service system configured by the virtual machine VM.

The management program 34_1 of the management server 34 provides a cloud user terminal 6, which operates a service system constructed by the virtual machines, with a portal site 34_2. The cloud user terminal 6 accesses the portal site 34_2 via an external network EX_NW and performs maintenance management of the service system.

The physical machines 1, 2, and 3, the management server 34, and the storage 9 are enabled to communicate with one another via a management network M_NW. An operation administrator terminal 7 of a server facility is accessible to the management server 34 via, for example, the management network M_NW. The cloud user terminal 6 accesses the management server 34 via the portal site 34_2 and requests a new creation, delete, or the like of a virtual machine.

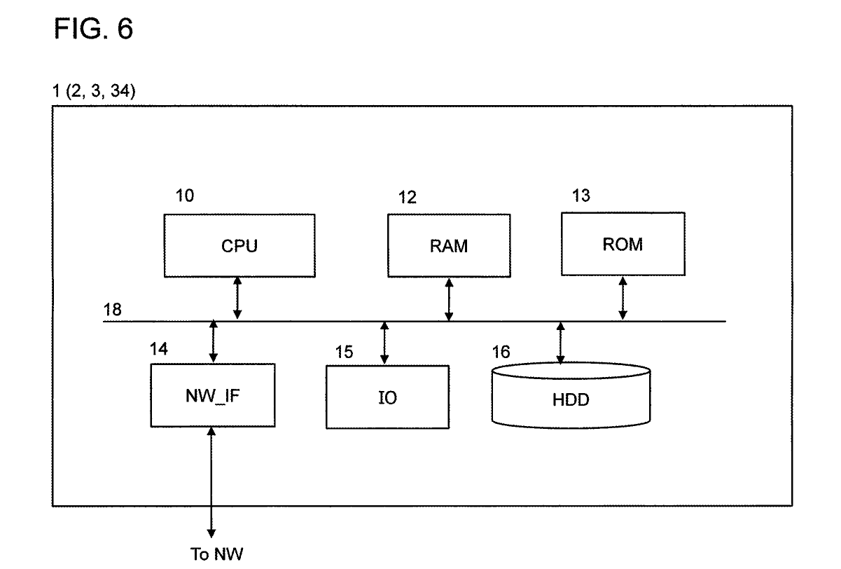

FIG. 6 is a diagram depicting the configuration of the physical machines 1, 2, and 3 and the management server 34 depicted in FIG. 5. The physical machines 1, 2, and 3 and the management server 34 include a CPU 10, which is an arithmetic processing device, a RAM 12 and a ROM 13, which are memories, a physical network interface 14, an input/output unit 15, and a large-capacity storage device 16 such as a hard disk, which are connected to one another via a bus 18.

In the case of the physical machines 1, 2, and 3, the large-capacity storage device 16 stores, for example, the OS and the hypervisor HV. In the case of the management server 34, the large-capacity storage device 16 stores, for example, the OS and the management program 34_1. The OS and the software stored in the large-capacity storage device 16 are expanded in the RAM 12, which is the memory, and executed by CPU cores.

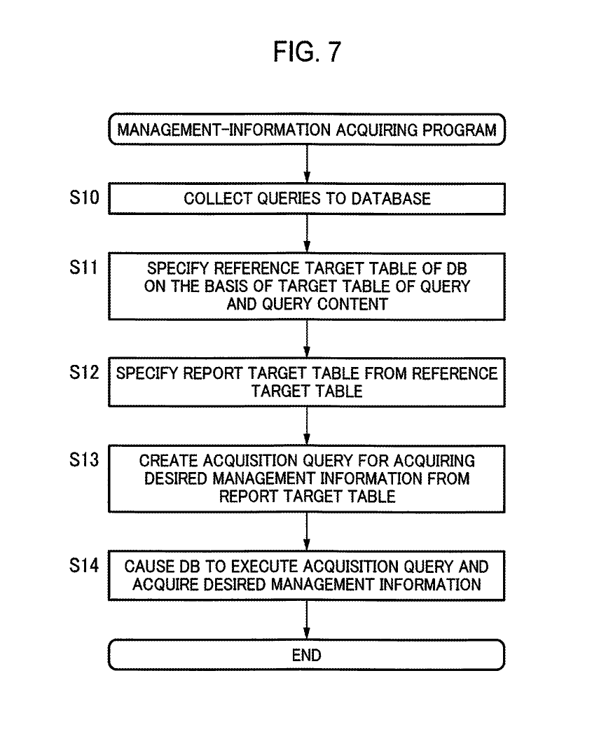

FIG. 7 is a flowchart for explaining processing of a management-information acquiring program in the first embodiment. The management-information acquiring program is the management-information acquiring agent depicted in FIG. 4. The management-information acquiring program is installed in a database server (not depicted in the figure) and executed to execute processing explained below.

The management-information acquiring program collects a query to a database (S10). Examples of the query to the database are explained in detail below. The query to the database is, for example, a Structured Query Language (SQL) sentence. A query includes a content of query and a name of a target table. Examples of the query include SELECT for acquiring data of a predetermined table in the database, INSERT for registering data in the predetermined table, and UPDATE for updating predetermined data in the predetermined table. The acquiring, registering, and updating are an example of the content of query, and the table is specified by the name in the query.

Examples of tables of the database include a table in which master data is stored, which is a reference target table often referred to by SELECT, and a table in which transaction data is stored, which is a non-reference target table in which data is registered and updated according to INSERT and UPDATE. The master data is data used in common in job applications and is fixed data not updated often. Therefore, the table of the master data is a table, the number of times of reference of which is larger than the numbers of times of registration and update thereof. The transaction data is data generated and recorded according to a job and is data that increases according to job processing. The table of the transaction data is a table, the numbers of times of registration and update of which are the same as or larger than the number of times of reference thereof.

Subsequently, the management-information acquiring program specifies the reference target table in the database on the basis of target tables of queries and query contents (S11). In the example of the query explained above, the management-information acquiring program determines, as the reference target table, a table, the number of times of becoming a target table of SELECT (the number of times of reference) of which is larger than the numbers of times of becoming target tables of INSERT and UPDATE (the number of times of registration and the number of times of update) thereof. The management-information acquiring program determines, as the non-reference target table, a table, the numbers of times of becoming the target tables of INSERT and UPDATE (the number of times of registration and the number of times of update) of which are the same as or larger than the number of times of becoming the target table of SELECT (the number of times of reference) thereof.

Subsequently, the management-information acquiring program specifies a reporting target table including management information from the specified reference target table (S12). The reporting target table can be specified by, for example, extracting, with SELECT, data of the reference target table in the database 33 and determining whether the data of the table corresponds to data peculiar to the management information and the reporting target table.

The management-information acquiring program creates an acquisition query for acquiring desired management information from the reporting target table. The acquisition query is, for example, SELECT targeting the reporting target table. The management-information acquiring program analyzes a plurality of queries acquired in step S10, recognizes the structure of the reporting target table, and generates the acquisition query on the basis of the recognized structure. In order to acquire the desired management information, the acquisition query of SELECT for setting a plurality of reporting target tables as the reference target table is sometimes needed. In that case, the management-information acquiring program analyzes joining information (an inner join phrase (INNER JOINT)) included in the plurality of queries collected in step S10 and generates a select sentence, which is the acquisition query. A specific example is explained below.

Finally, the management-information acquiring program causes the database to execute the acquisition query to acquire desired management information (S14). The management-information acquiring program provides the management server with the acquired management information.

According to the first embodiment, the management-information acquiring agent (the management-information acquiring program) is installed in the database server of the service system. The management-information acquiring agent collects and analyzes a query to the database. The management-information acquiring agent analyzes the query to specify the reference target table in the database and further specifies the reporting target table and generates the acquisition query for acquiring data from the reporting target table. The management-information acquiring agent causes the database to execute the acquisition query and acquires the desired management information.

Therefore, the management server can acquire the desired management information from the database of the service system without directly accessing the database in the service system and without acquiring the structure of the database beforehand. The management-information acquiring agent acquires only the desired management information necessary for the management server and provides the management server with the desired management information rather than directly supplying the raw data of the database to the management server.

### Second Embodiment

In a second embodiment, the desired management information and the management-information acquiring agent in the first embodiment are respectively priority information and a priority-information acquiring agent (a priority-information acquiring program) for improving the response performance of the Web server explained with reference to FIGS. 1 and 2. In the second embodiment, the invention is more specifically explained with reference to an example in which the priority-information acquiring program acquires priority information of performance improvement from the job database. In the second embodiment, the reference target table is a master data table, the reporting target table is a user table and a country data table, and the priority information is the number of users by country.

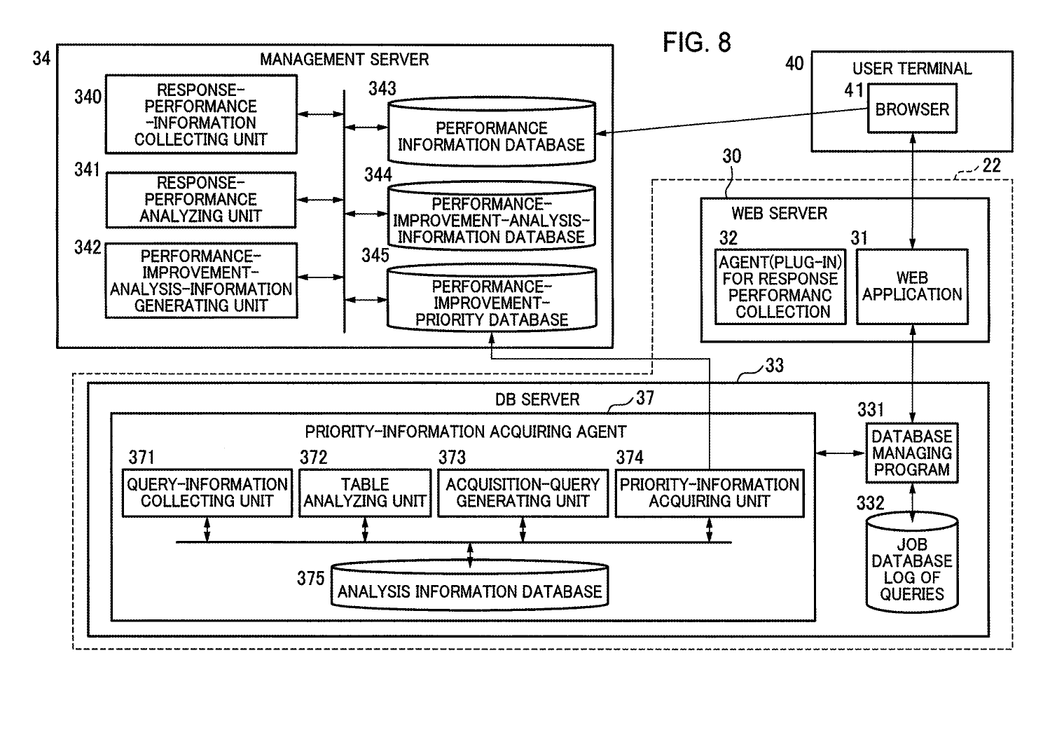

FIG. 8 is a diagram depicting a configuration information of a management server and a service system in the second embodiment. As in the first embodiment depicted in FIG. 4, the user system 22 includes the Web server 30 and a database server 33. The management server 34 collects response performance of the Web server 30, collects priority information of performance improvement, and generates performance improvement analysis information. The management server 34 installs the priority-information acquiring agent (program) 37 in the database server 33.

The Web server 30 executes the Web application 31 for controlling an access from the user terminal 40 and further executes a response performance collection plug-in (or agent) 32 for embedding a script for response performance information collection in an HTML file for responding to a request from the user terminal 40.

The user terminal 40 installs a browser 41 and accesses the Web server 30 via a network such as the Internet or an intranet.

In the management server 34, a response-performance-information collecting unit 340 receives response performance information collected by the script from the user terminal 40 and stores the response performance information in a performance information database 343. In the performance information database 343, information concerning system performance of a CPU, a memory, and the like of the Web server 30 is also stored.

A response-performance analyzing unit 341 analyzes the data stored in the performance information database 343, generates a performance-improvement-analysis-information database 344, and analyzes response performance on the basis of the performance-improvement-analysis-information database 344. A performance-improvement-analysis-information generating unit 342 stores the priority information of the performance improvement transmitted from the priority-information acquiring agent 37 in a performance-improvement-priority database 345. Further, the response-performance analyzing unit 341 registers the performance improvement priority information in the performance-improvement-analysis-information database 344.

In the database server 33, a database managing program 331 executes various queries, which is transmitted from the Web application 31, to reflect the queries on a job database 332 or return reference data. The database server 33 executes the priority-information acquiring agent 37 to transmit acquired priority information to the management server. The priority-information acquiring agent 37 includes a query-information collecting unit 371 that collects a query and a table analyzing unit 372 that analyzes a table of a job database 332 on the basis of the collected query. Further, the priority-information acquiring agent 37 includes an acquisition-query generating unit 373 that generates a query for acquiring priority information and a priority information acquiring unit 374 that searches through job data with the query for acquiring to acquire desired priority information. These kinds of processing are specifically explained below. The priority-information acquiring agent 37 includes an analysis information database 375.

Acquisition processing for priority information by the priority-information acquiring agent (program) 37 and generation processing for performance improvement analysis information by the management server 34 are explained below with reference to a specific example.

First, as a premise, examples of various tables included in the job database 332 are explained.

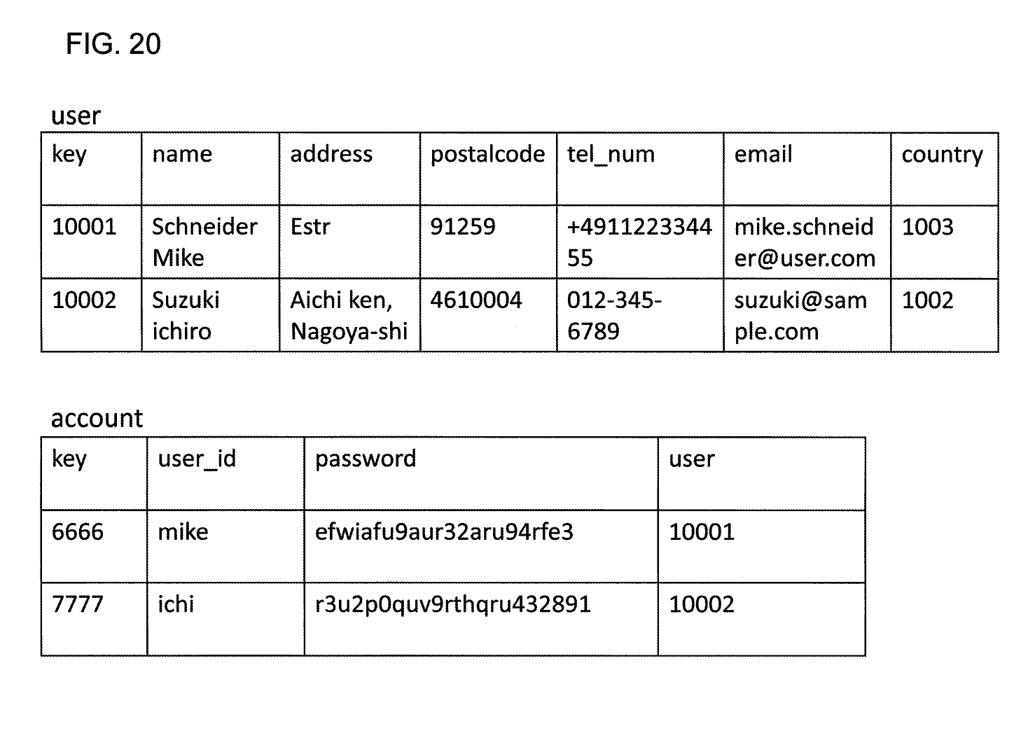

FIG. 20 is a diagram depicting an example of a user table “user” and an account table “account” included in the job database. The user table “user” includes data of a key number “key”, a name “name”, an address “address”, a postal code “postalcode”, a telephone number “tel_num”, a mail address “email”, a country code “country”. The account table “account” includes authentication information such as a key number “key”, a user ID “user_id”, a password “password”, and a user number “user”.

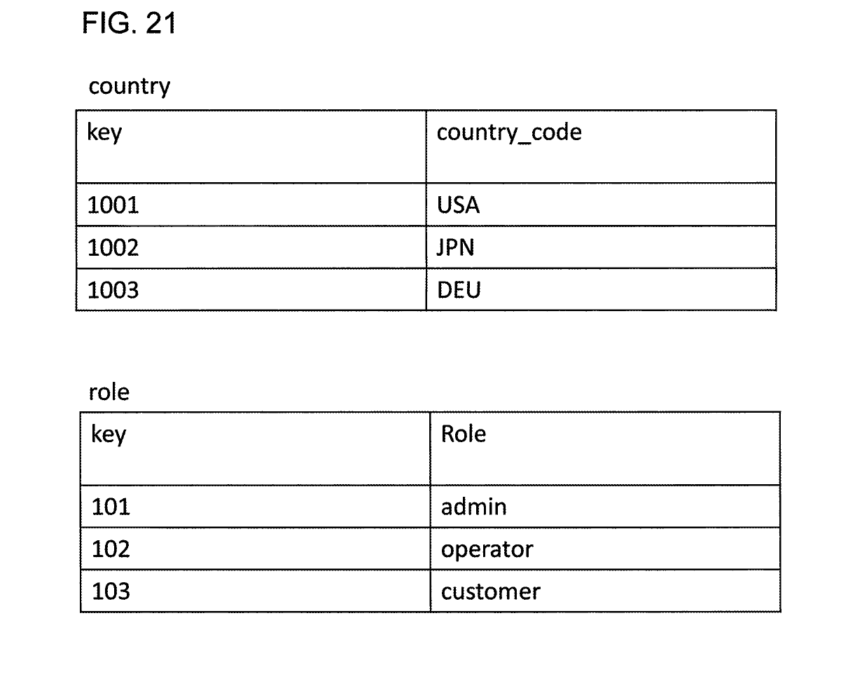

FIG. 21 is a diagram depicting an example of a country data table “country” and a role table “role” included in the job database. The country data table “country” includes data of a key number “key” and a country code “country_code”. The role table “role” includes data of a key number “key” and a role “role”.

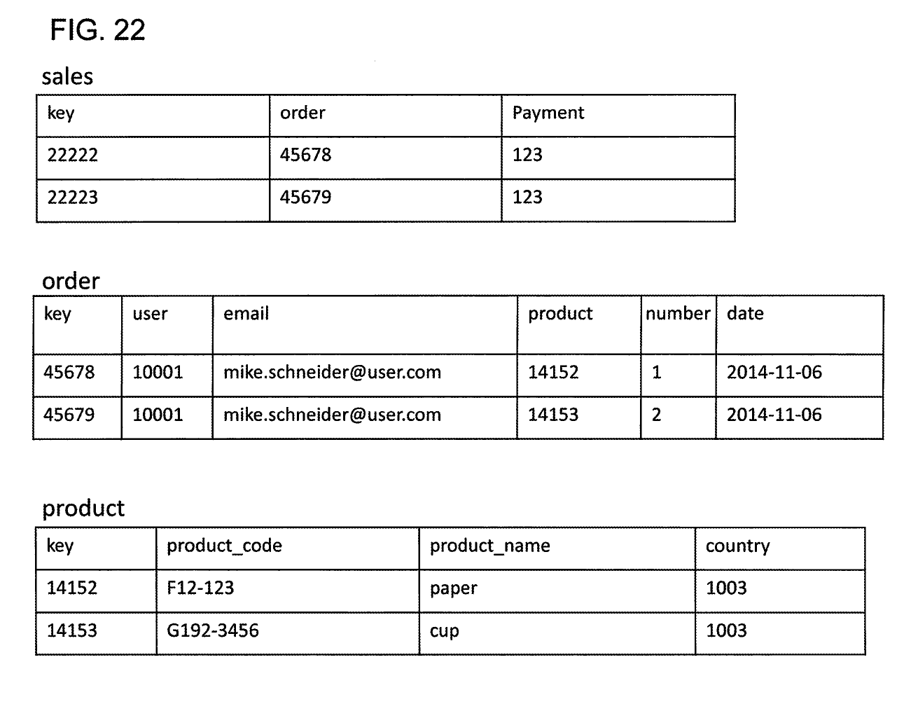

FIG. 22 is a diagram depicting an example of a sales data table “sales”, an order table “order”, and a product table “product” included in the job database. The sales data table “sales” includes data of a key number “key”, an order number “order”, and a payment amount “payment”. The order table “order” includes data of a key number “key”, a user “user”, a mail address “email”, a product “product”, the number of pieces “number”, and a date “date”. The product table “product” includes data of a key number “key”, a product code “product_code”, a product name “product_name”, and a country number “country”.

Among the tables, the user table “user”, the account table “account”, the country data table “country”, the role table “role”, and the product table “product” belong to the reference target table, the number of times of reference of which by SELECT is large. The sales data table “sales” and the order table “order” are tables including transaction data generated according to job execution and belong to the non-reference target table.

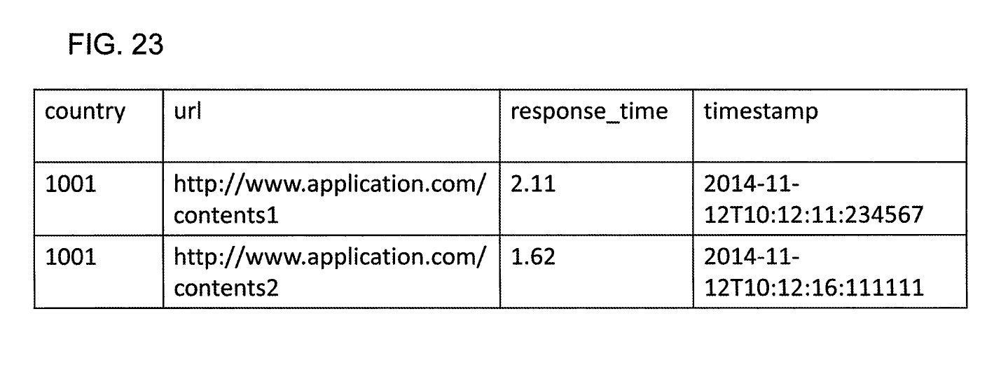

FIG. 23 is a diagram depicting an example of a response performance table in the performance information database 343 stored by the management server 34. The response performance table includes data of a country number “country”, a URL “url”, a response time “response_time”, and a time stamp “timestamp”. The URL is information concerning a request destination transmitted from a user terminal. The management server 34 receives response performance information collected by a script embedded in an HTML file of a response and stores the response performance information in the response performance table in the performance information database 343.

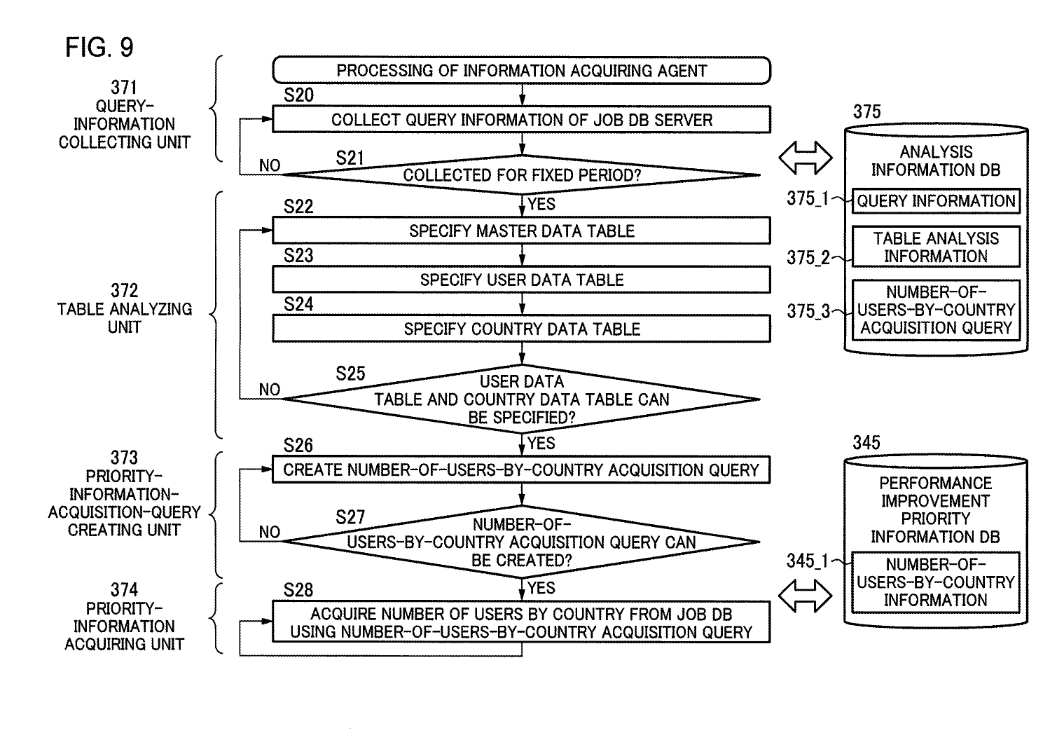

FIG. 9 is a flowchart for explaining schematic processing of the priority-information acquiring agent 37 in the second embodiment.

Collection of Query Information S20

The query-information collecting unit 371 of the priority-information acquiring agent 37 (hereinafter simply referred to as agent 37) collects query information to the job database 332 and stores the query information in a query information table 375_1 in the analysis information database 375 (S20). The DB managing program 331 of the database server 33 receives and executes queries and stores a log of the received queries in a storage device of the job database 332. Therefore, the query-information collecting unit 371 collects queries for a fixed time (e.g., one day) from the log of the queries in the job database 332 (S21).

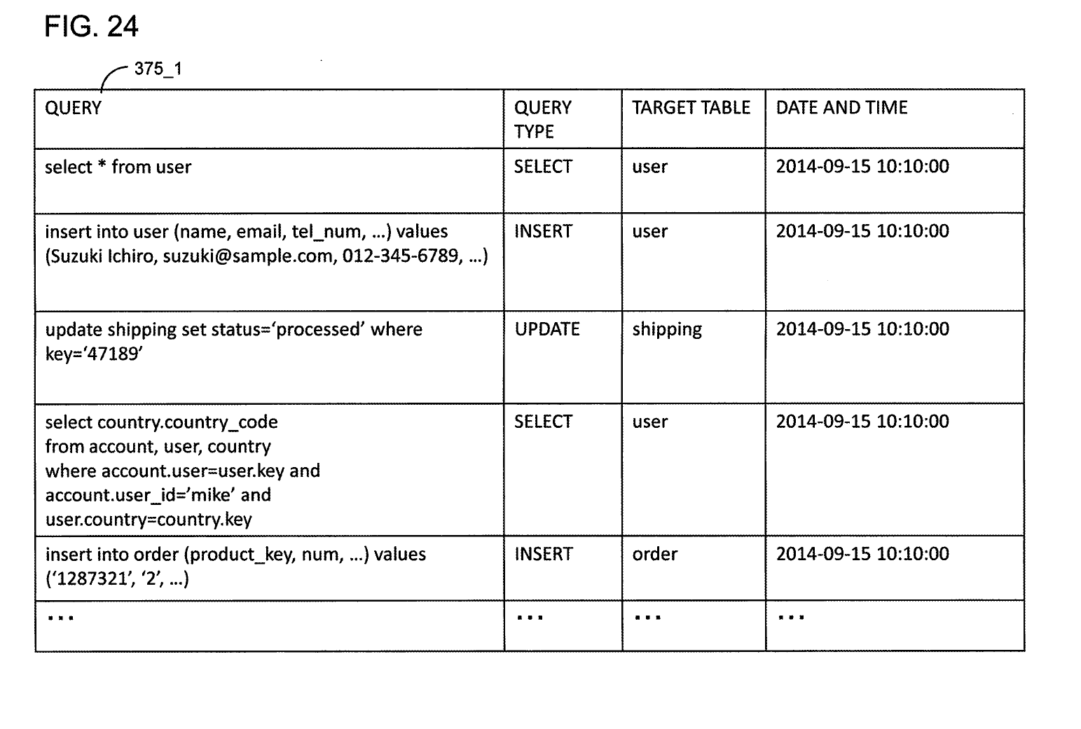

FIG. 24 is a diagram depicting an example of the query information table 375_1. The query information table 375_1 includes a query, a query type, a target table, and data of creation date and time. In the example depicted in FIG. 24, five queries are stored. The queries are as explained below.

The query in a first row is a select sentence for outputting all data in the user table “user”. “*” after the select sentence means all the data. The query type is SELECT. The target table is “user”.

The query in a second row is an insert sentence for registering values “Suzuki Ichiro, Suzuki@sample.com, and 012-345-6789” respectively in columns of the name, the mail address, and the telephone number of the user table “user”. That is, the query is a query for registering a user in the user table. The query type is INSERT. The target table is “user”.

The query in a third row is an update sentence for updating a status “status” of a row of the key number “key” 47189 to “processed” in a shipping table “shipping”. The query type is UPDATE. The target table is “shipping”.

The query in a fourth row is a select sentence for combining the account table “account”, the user table “user”, and the country data table “country” and outputting information of a country name “country.country_code” of the country table of a record in which a user ID “account.user_id” of the account table is “mike”, a user number “account.user” of the account table and a key number “user.key” of the user table are equal, and a country number “user.country” of the user table and a key number “country.key” of the country data table are equal. The query type is SELECT. The target table is three tables, i.e., the account table “account”, the user table “user”, and the country data table “country”.

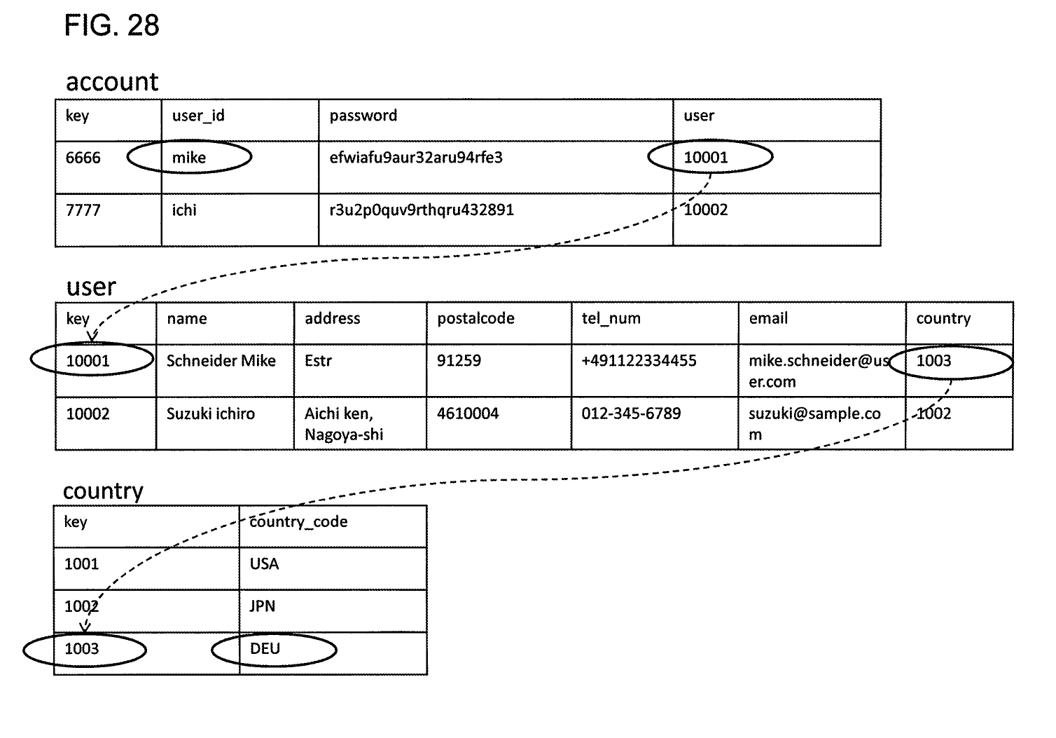

FIG. 28 is a diagram depicting arithmetic processing of the query in the fourth row of FIG. 24. As depicted in FIG. 28, the query in the fourth row can extract, with respect to a row in which the user ID “account.user_id” of the account table is “mike, “DEU” of the country name “country.country_code” of the country data table via a joining phrase (JOIN phrase) of account.user=user.key and user.country=country.key.

A query in a fifth row of FIG. 24 is an insert sentence for registering values “1287321 and “2” in a product key number “product_key” and a number “num” of the order table “order”. The query type is INSERT. The target table is the order table.

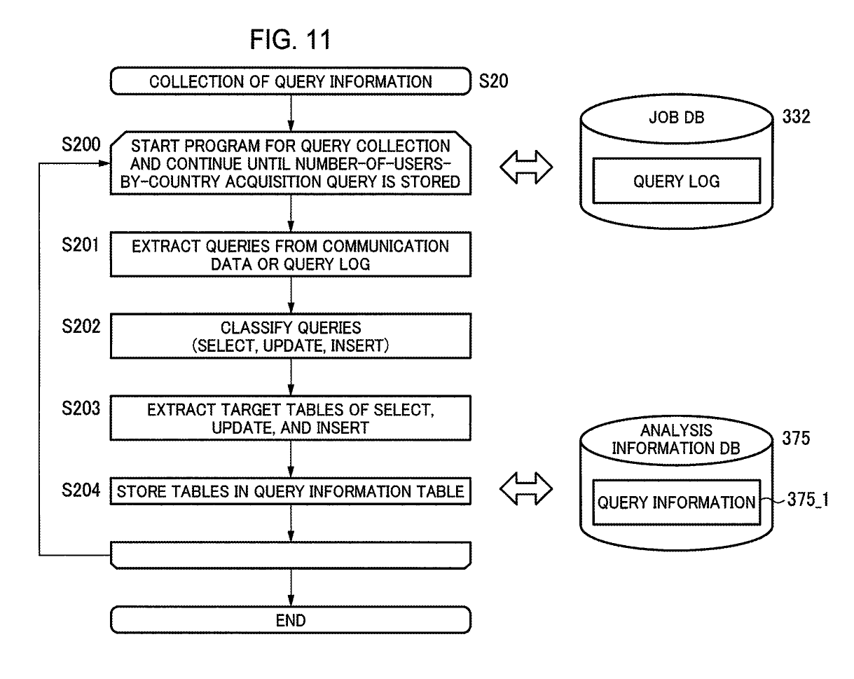

FIG. 11 is a detailed flowchart of the collecting step S20 for query information. The query-information collecting unit 371 starts a program for query collection and collects query information in the background and generates the query information table 375_1 until acquired queries are stored by the number of users by country (S200). First, the query-information collecting unit 371 extracts queries from communication data passing a network apparatus between the Web server 30 and the database server 33 or a query log generated by the job database (S201). The query-information collecting unit 371 classifies the queries into SELECT, UPDATE, and INSERT (S202), extracts target tables of the queries (S203), and stores the target tables in the query information table (S204). As a result, the query information table 375_1 depicted in FIG. 24 is generated.

Specifying of the master data table S22, specifying of the user table S23, and specifying of the country data table S24

Referring back to FIG. 9, the table analyzing unit 372 of the priority-information acquiring program 37 specifies, from the target tables of the queries and contents of the queries (the query types) collected in the query information table 375_1, the reference target table solely set as a target of reference of data, that is, a table that stores master data (the master data table) (S22). Further, the table analyzing unit 372 specifies, out of a specified plurality of master data tables, the user table referring to data of the tables (S23) and further specifies the country data table (S24).

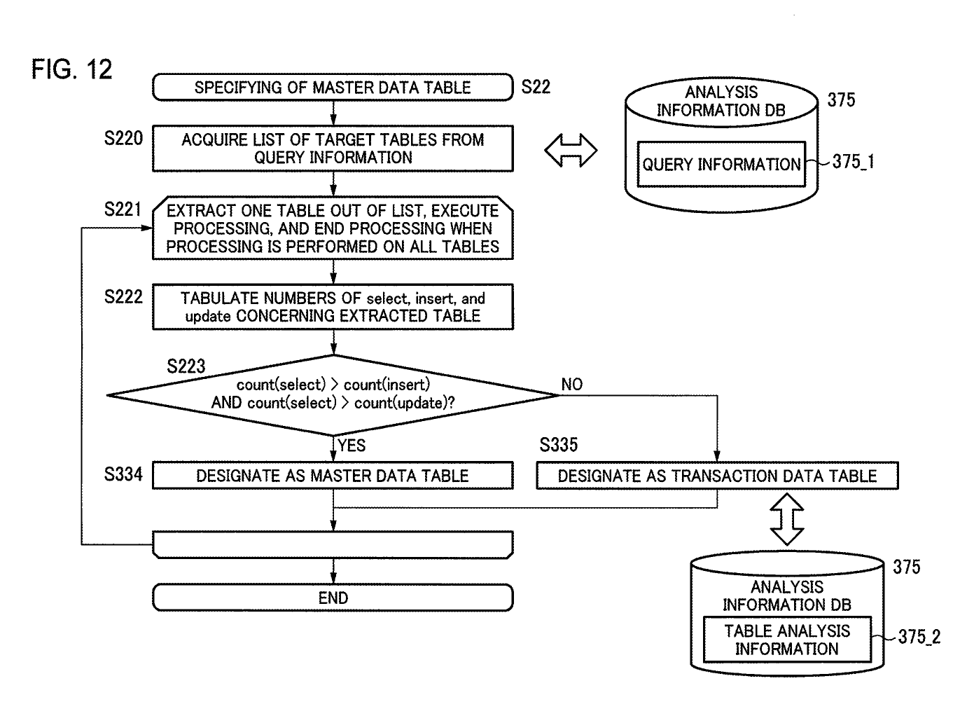

FIG. 12 is a detailed flowchart of the specifying processing S22 for the master data table. The master data table, which is the reference target table, has characteristics explained below. In the job database, master data and transaction data are stored in various tables. The master data is data used in common in job applications and is fixed without being updated often. The master data is, for example, user data and commodity data. Therefore, in the table that stores the master data (the master data table or the reference target table), the number of times of reference of which by queries such as a select sentence is large. The numbers of times of registration and update are smaller than the number of times of reference.

On the other hand, the transaction data is data in which incidents that occur according to a job are recorded. The transaction data increases according to job processing. The transaction data is, for example, purchase data and deposit/withdrawal data. Therefore, the number of times the table that stores the transaction data (the transaction table or the non-reference target table) is referred to by queries is small. The numbers of times of registration and update by an insert sentence and an update sentence is the same as or larger than the number of times of reference.

Therefore, in the specifying processing S22 for the master data table in FIG. 12, the master data table is specified from content of a query (reference or update and registration) and a table targeted by the query on the basis of the above-mentioned difference between the master data table and the transaction table.

The table analyzing unit 372 acquires a list of target tables from the query information (S220). The list of tables is stored in a column of “target table” of FIG. 24. Subsequently, the table analyzing unit 372 extracts the tables from the list and performs processing explained below on all the tables (S221). That is, the table analyzing unit 372 tabulates numbers by query types (SELECT, INSERT, and UPDATE) concerning the extracted tables (S222) and determines whether the number of times of SELECT (the number of times of reference) is larger than the number of times of INSERT (the number of times of registration) and/or the number of times of SELECT is larger than the number of times of UPDATE (the number of times of update) (S223). If the determination is YES, the table analyzing unit 372 designates the extracted tables as the master data table (the reference target table) (S224). If the determination is NO, the table analyzing unit 372 designates the extracted tables as the transaction data table (the non-reference target table) (S225). Determination results of the tables are stored in a table analysis information table 375_2 in the analysis information database 375.

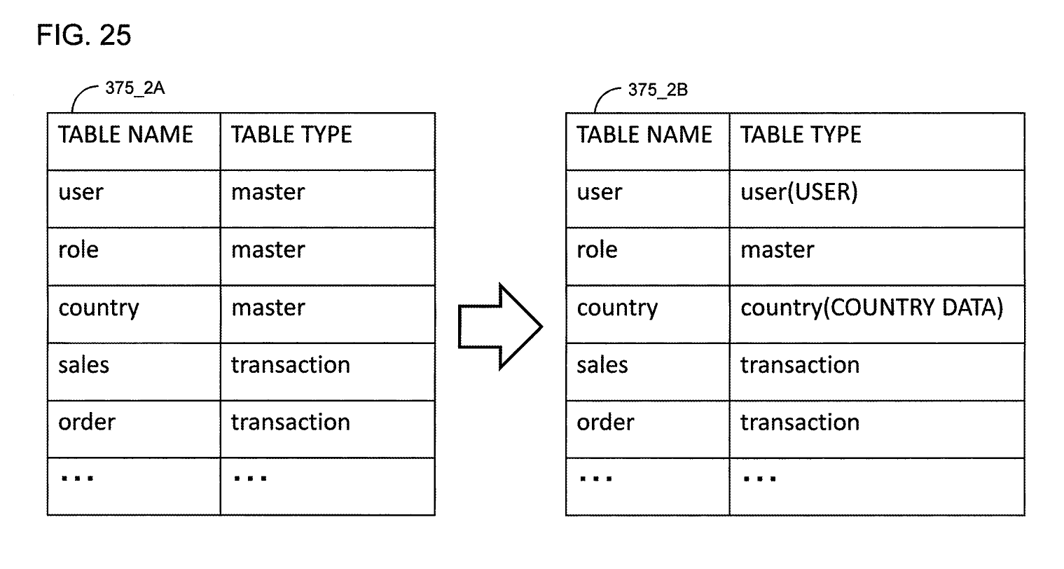

FIG. 25 is a diagram depicting an example of the table analysis information table. In a table analysis information table 375_2A on the left side in FIG. 25, tables are specified as the master data table or the transaction data table in a column of a table type.

Referring back to FIG. 9, the table analyzing unit 372 specifies the user table from the tables designated as the master data table (S23).

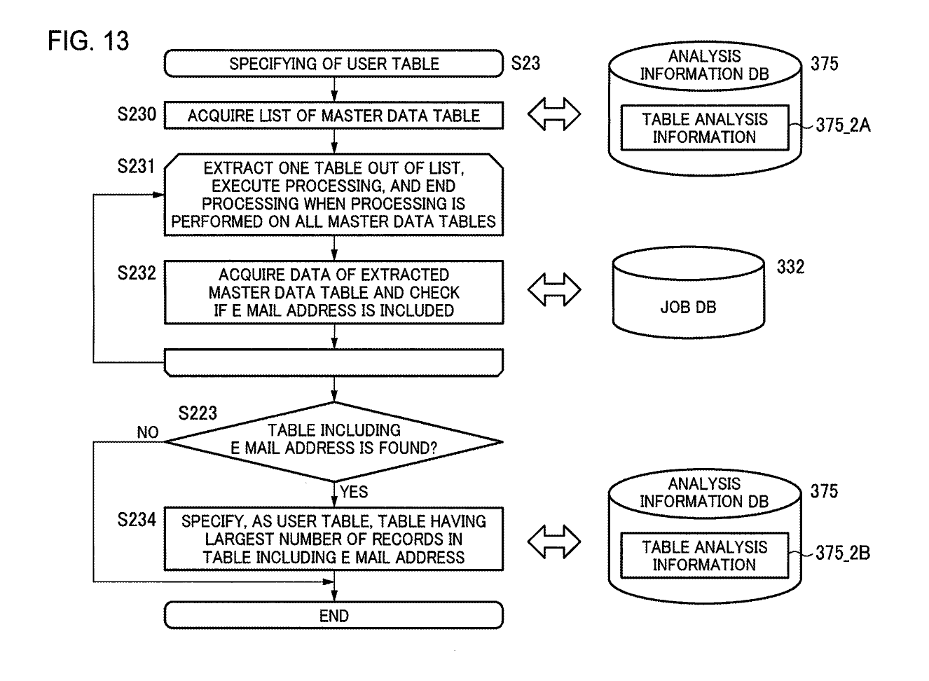

FIG. 13 is a detailed flowchart of the specifying processing S23 for the user table by the table analyzing unit. The table analyzing unit 372 acquires a list of master data tables from the table analysis information table 375_2 (S230). The table analyzing unit 372 extracts one table from the list and performs processing explained below on all the tables (S231). That is, the table analyzing unit 372 acquires data of the extracted master data table and checks whether an electronic mail address is included in the data (S232). If tables including electronic mail addresses are found (YES in S233), the table analyzing unit 372 specifies, as the user table, a table having the largest number of records among the tables including the electronic mail addresses (S234).

In general, tables including electronic mail addresses are also present in the master data tables other than the user table. The tables are, for example, an organization data table, a delivery data table, and a bill data table.

The organization table is data of a company or a department to which the user belong. As data content, a company name (a department name), a head office address, a representative telephone number, a representative electronic mail address, and the like are included. When users are registered in organization units, the organization data is treated as the user data. However, when both of the user data and the organization data are present, in general, the number data is larger in the user data than in the organization data. Therefore, when a table including a plurality of electronic mail addresses is found, it is appropriate to specify a table having a large number of data as the user table. When the user data is absent and only the organization data is used as the user data, it is desirable to regard the organization data as the user data and specifies the organization data as the user data.

The electronic mail addresses of the user and the organization are sometimes included in the delivery data table and the bill data table as well. However, since the delivery data table and the bill data table are determined as the transaction data table, the delivery data table and the bill data table are not the determination target table in the specifying processing S23 for the user table.

Referring back to FIG. 9, the table analyzing unit 372 specifies the country data table from the tables designated as the master data table (S24). The table analyzing unit 372 repeats the processing S23 and S24 until the user table and the country table can be specified (S25).

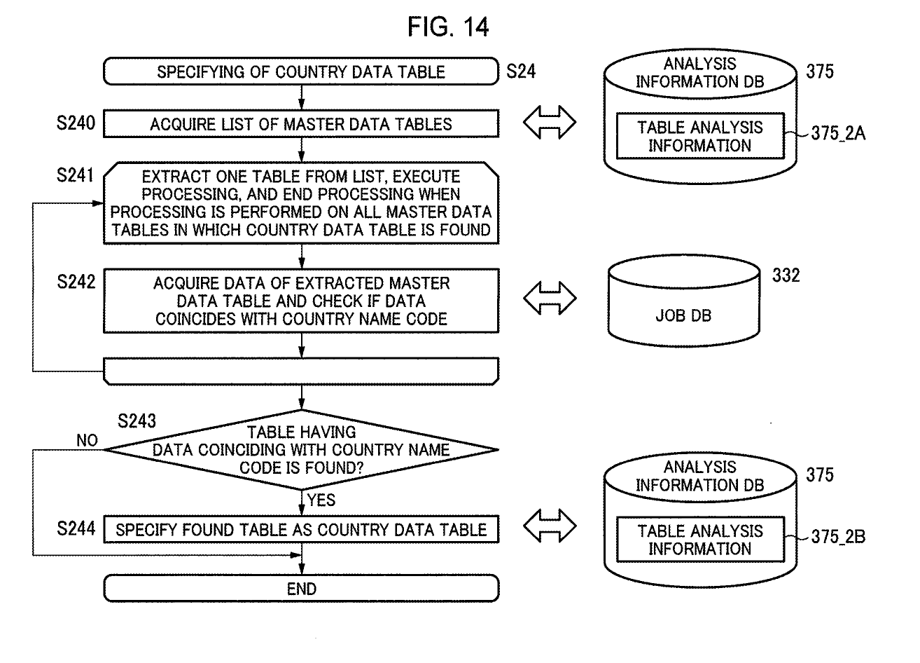

FIG. 14 is a detailed flowchart of the specifying processing S24 for the country data table by the table analyzing unit. The table analyzing unit 372 acquires the list of master data table from the table analysis information table 375_2 (S240). The table analyzing unit 372 extracts the table from the list one by one and performs processing explained below on all the tables S241). That is, the table analyzing unit 372 acquires data of the extracted master data table and checks whether data coinciding with the country code is included in the data (S242). If a table including data coinciding with the country code is found (YES in S243), the table analyzing unit 372 specifies the table as the country data table (S244).

Representative country name codes are as described in a table below.

TABLE 1

| Country | | |
|---|---|---|
| name code | Explanation | Code example |
| ISO 3166-1 | Country name code by two Latin | Japan: JP, |
| alpha-2 | characters | United States: US |
| ISO 3166-1 | Country name code by three | Japan: JPN, |
| alpha-3 | Latin characters | United States: USA, |
| | | Indonesia: IDN |
| ISO 3166-1 | Country name code by three-digit | Japan: 392, |
| numeric | number | United States: 840 |
| FIPS 10-4 | Country name code of two | Japan: JA, |
| | characters by the American | United States: US |
| | Federal Information Processing | |
| | Standard | |
| IOC code | List of country name codes in the | Japan: JPN, |
| | International Olympics | United States: USA, |
| | Committee (IOC) | Indonesia: INA |
| FIFA code | List of country name codes in the | Japan: JPN, |
| | Federation of International | United States: USA, |
| | Football Association s(FIFA) | Indonesia: IND |
| International | List of telephone numbers | Japan: 81, |
| telephone | necessary when making a call | United States: 1 |
| number | across countries (an international | |
| (ITU-TE. 164) | call) | |

The table analyzing unit 372 determines, as the country data table, a table including data coinciding with any one of the country name codes.

In a table analysis information table 375_2B on the right side of FIG. 25, table types, “a user” and “a country” are respectively registered in tables “user” and “country”.

Creation of a number-of-users-by-country acquisition query creation S26 and number-of-users-by-country acquisition S28

Referring back to FIG. 9, a performance-improvement-priority-information-acquisition-query creating unit 373 analyzes the queries collected in step S20 and creates a number-of-user-by-country-information acquisition query (S26 and S27). In the second embodiment, number-of-users-by-country information corresponds to the performance improvement priority information in the first embodiment. Therefore, the number-of-user-by-country-information acquisition query corresponds to the performance-improvement-priority-information acquisition query.

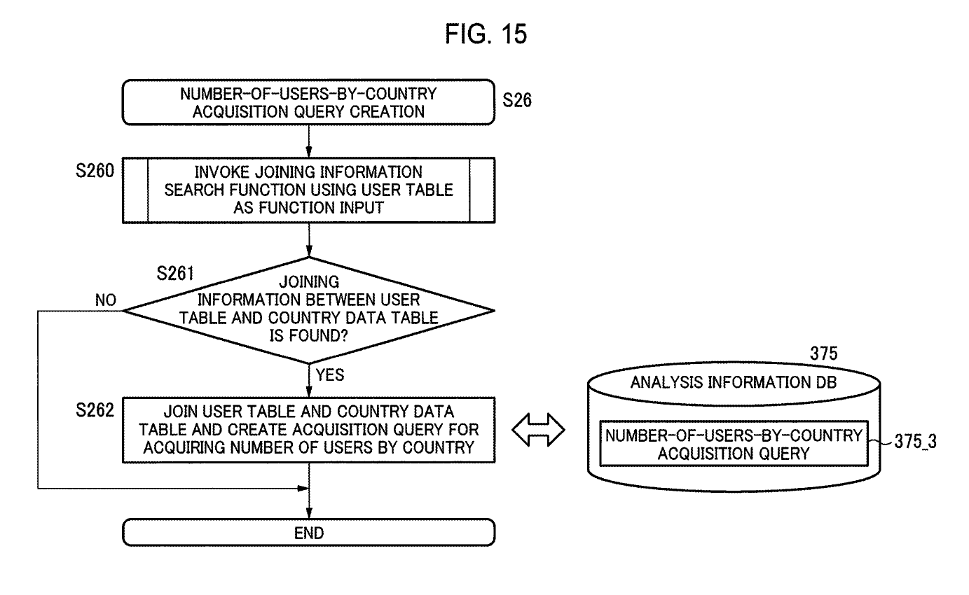

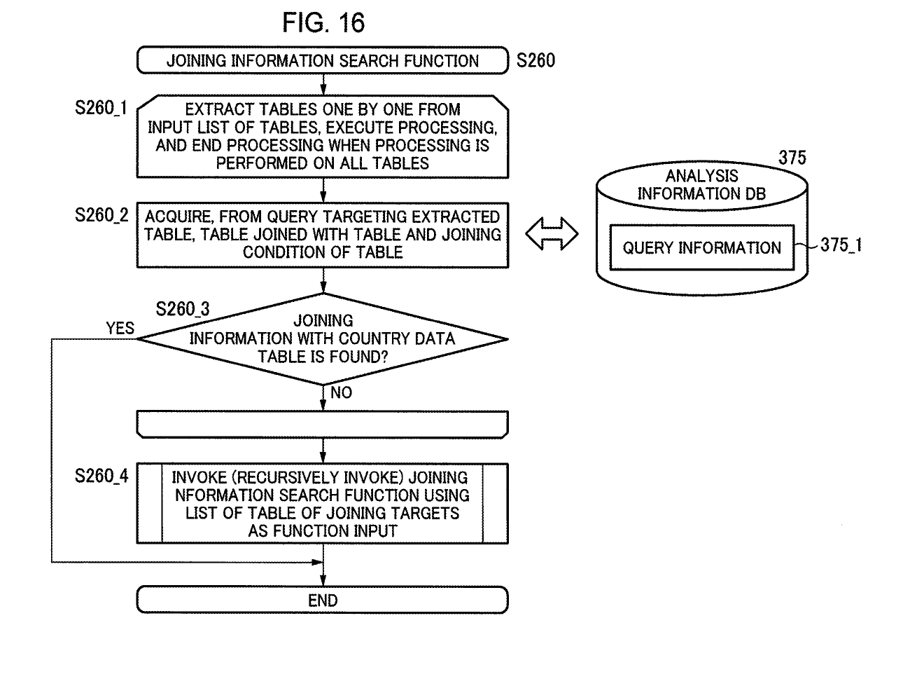

FIG. 15 is a detailed flowchart of the number-of-users-by-country acquisition query creation S26 by the acquisition-query creating unit. FIG. 16 is a flowchart of a joining information search function. As depicted in FIG. 15, the acquisition-query creating unit 373 receives the user table as an input of a function and invokes a joining information search function (S260). If the joining information search function detects joining information between the user table and the country data table (YES in S261), the acquisition-query creating unit 373 joins the user table and the country data table and creates an acquisition query for acquiring the number of users by country (S262). The acquisition query is stored in a number-of-users-by-country acquisition query table 375_3 in the analysis information database 375.

The joining information corresponds to a JOIN phrase and a target table name in a query. When a JOIN phrase is included in a query, the joining information between target tables of the query can be detected from the JOIN phrase. The joining information between specific tables can be sometimes detected from JOIN phrases and target tables of a plurality of queries.

The JOIN phrase is explained with reference to the five queries of the query information table of FIG. 24 as an example. In all of the queries in the first, second, third, and fifth rows, the target table is one table, i.e., “user”, “user”, “shipping”, or “order”. Therefore, a JOIN phrase is not included in the queries. On the other hand, in the query in the fourth row, the target table is a plurality of tables, i.e., “account”, “user”, and “country”. Since the plurality of tables are referred to, a JOIN phrase is included in the query. Further, “account.user=user.key” and “user.country=country.key” in a “where” phrase respectively indicate a joining relation between the tables “account” and “user” and a joining relation between the tables “user” and “country”. Concerning this point, if FIG. 28 for explaining the query in the fourth row is referred to, joining information among the three target tables can be understood.

The joining information search function in FIG. 16 extracts the tables one by one from a list of collected tables of the query information table 375_1 and executes processing explained below (S260_1). The table to be extracted is desirably started from the user table or the country code table. First, the joining information search function acquires, from a query targeting the extracted table, other tables joined with the table and joining information of the tables (5260_2). First, the joining information search function desirably acquires, from a query targeting the user table, tables joined with the user table and joining conditions of the tables. Alternatively, the joining information search function may extract the table from the country code table and perform the processing.

The joining information search function checks all queries targeting the user table and, if joining information of the user table and the country data table is found (YES in S260_3), the joining information search function ends the processing. If the joining information is not found (NO in S260_3), the joining information search function invokes the joining information search function again using a table to be joined with the user table as a function input (S260_4). A reason why the joining information search function is recursively invoked in this way is explained below.

In an example depicted in FIG. 28, the user table “user” and the country code table “country” can be joined by the country code “user.country” of the user table and the key number “country.key” of the country code table. Therefore, for example, if the user table and the country code table are included in a target table of a certain query and a joining relation of both the tables is included by a JOIN phrase or a “where” phrase, the joining information search function can acquire relation information between the user table and the country code table at a time. For example, the query alone in the fourth row in the query information table in FIG. 24 indicates the joining relation between the user table and the country code table. However, a relation between the user table and the country code table is sometimes found via other tables.

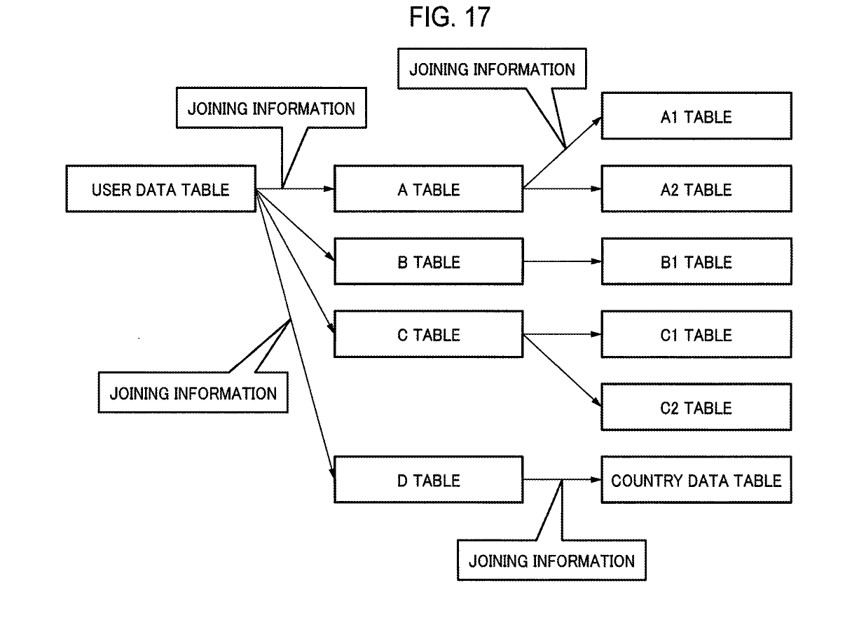

FIG. 17 is a diagram depicting an example in which the user table and the country code table has a relation via other tables. In an example depicted in FIG. 17, the user table has a joining relation with an A table, a B table, a C table, and a D table. The A table has a joining relation with A1 and A2 tables. The B table has a joining relation with a B1 table. The C table has a joining relation with C1 and C2 tables. The D table has a joining relation with the country data table.

In the case of such an example, when a certain query includes a JOIN phrase targeting the user table and the D table and includes a joining information between the user table and the D table, the joining information search function detects the joining relation between the user table and the D table. By recursively invoking the joining information search function using the D table having the joining relation with the user table as a function input, the invoked joining information search function detects the joining information between the D table and the country data table. As a result, it is detected that the user table and the country data table has a joining relation via the D table.

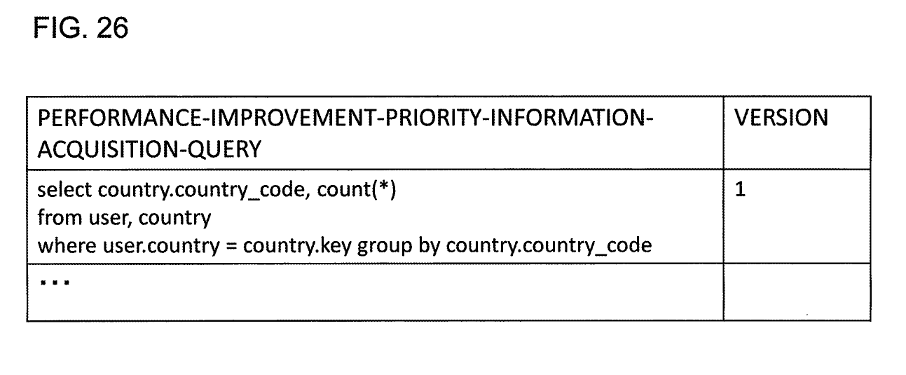

FIG. 26 is a diagram depicting an example of a number-of-users-by-country-information acquisition query in the second embodiment. Referring to the relation between the user table and the country code table depicted in FIG. 28, the acquisition query is a select sentence “select” for extracting all numbers (“count(*)”) obtained by grouping, with the country code “country.country_code” of the country code table, records satisfying a condition (“user.country=country.key”) in which the country number “user.country” of the user table and the key number “country.key” of the country code table are equal in the user table “user” and the country code table “country”.

That is, the acquisition query depicted in FIG. 26 is created from the query in the fourth row in FIG. 24 on the basis of the joining information between the user table and the country code table depicted in FIG. 28.

Referring back to FIG. 9, a performance-improvement-priority-information acquiring unit 374 acquires the number of users by country from the job database using the acquisition query (S28).

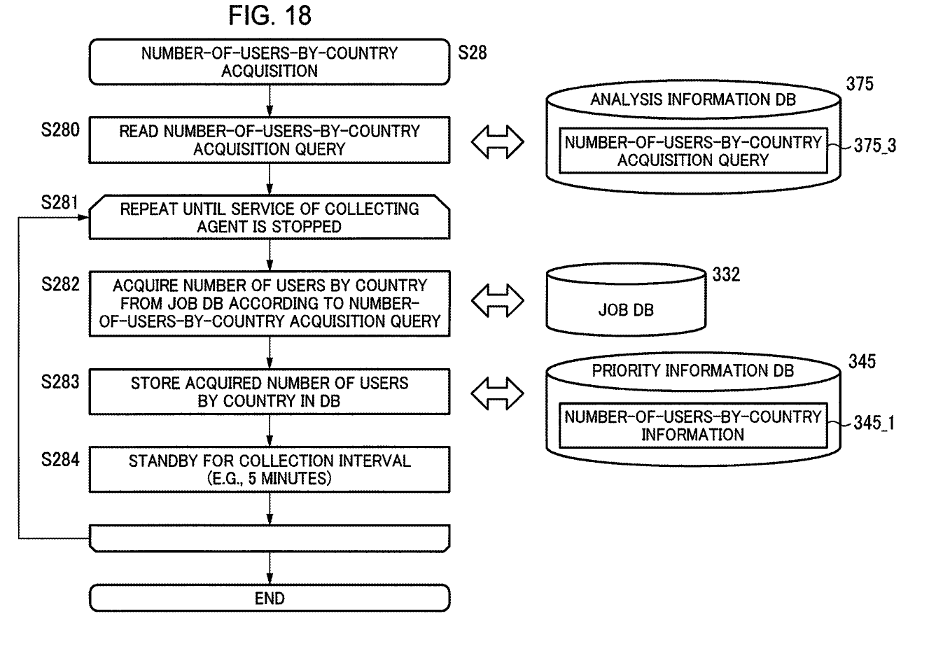

FIG. 18 is a detailed flowchart of the number-of-users-by-country acquisition processing S28, which is priority information by the priority-information acquiring unit 374. The priority-information acquiring unit 374 reads the number-of-users-by-country acquisition query table 375_3 in the analysis information database 375 (S280) and executes processing explained below while a service of the management-information acquiring agent 37 is operating (S281). That is, the priority-information acquiring unit 374 acquires the number of users by country from the job database 332 according to a number-of-users-by-country acquisition query (S282) and registers the acquired number of users by country in a number-of-users-by-country information table 345_1 in a priority information database 345 (S283). The priority-information acquiring unit 374 repeats, at every collection interval (e.g., 5 minutes), the acquisition processing for the number of users by country (S284).

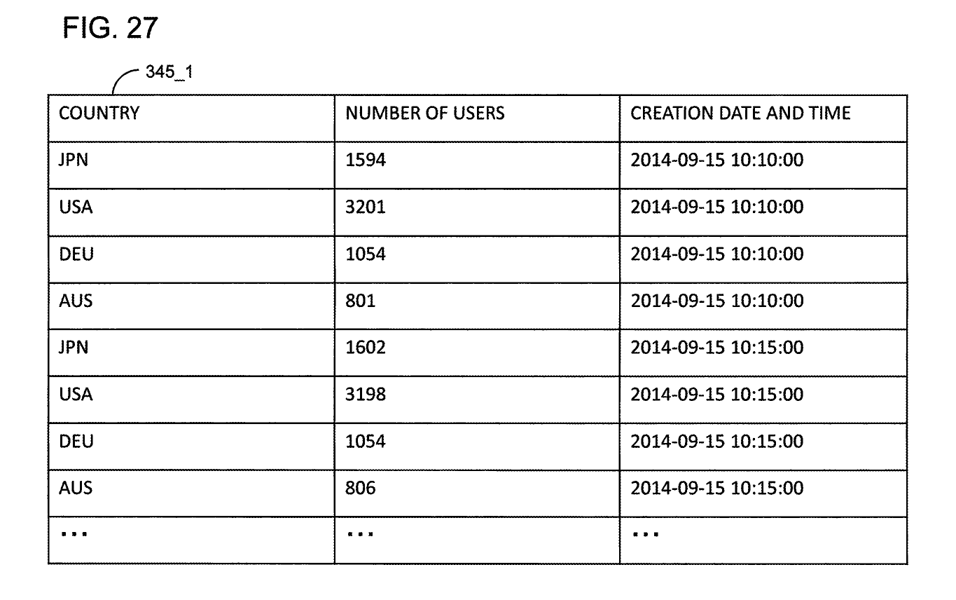

FIG. 27 is a diagram depicting an example of the number-of-users-by-country information table including the number of users by country acquired by the acquisition query. The number-of-users-by-country information table 345_1 is a table generated in the performance-improvement-priority database 345 of the management server 34. As depicted in FIG. 27, the number of users by country and acquisition date and time are stored in the number-of-users-by-country information table 345_1. The acquisition date and time is set to an interval of 5 minutes.

Generation of a performance improvement analysis information DB by a monitoring server S29

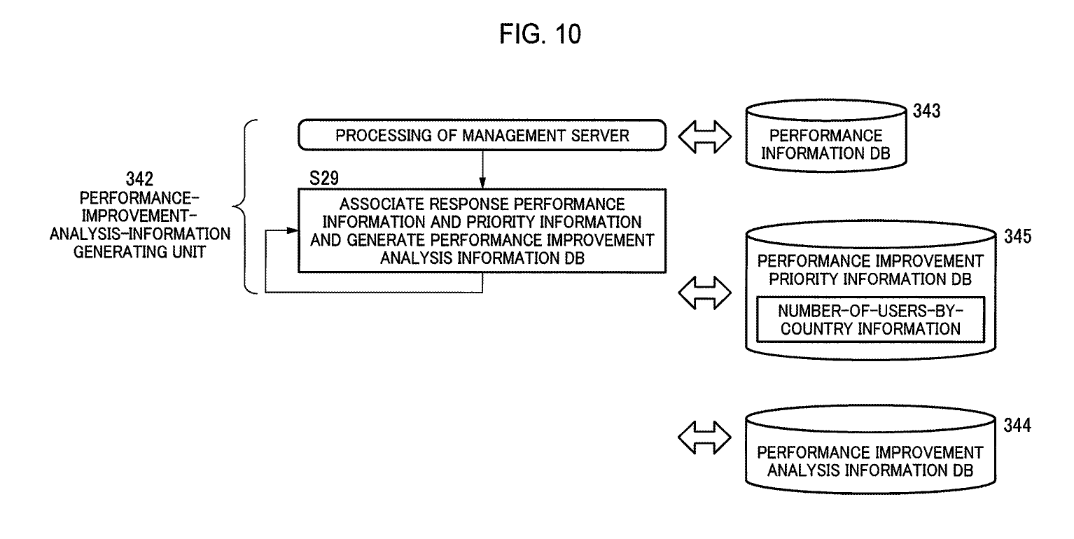

FIG. 10 is a flowchart of processing by the performance-improvement-analysis-information generating unit 342 of the management server. The performance-improvement-analysis-information generating unit 342 associates the response performance information in the performance information database 343 and the priority information of the priority information database 345 and generates the performance-improvement-analysis-information database 344. In the second embodiment, the response performance is response speed, the performance improvement priority information is the number of users by country, and the performance-improvement-analysis-information database is a number-of-users-by-country table.

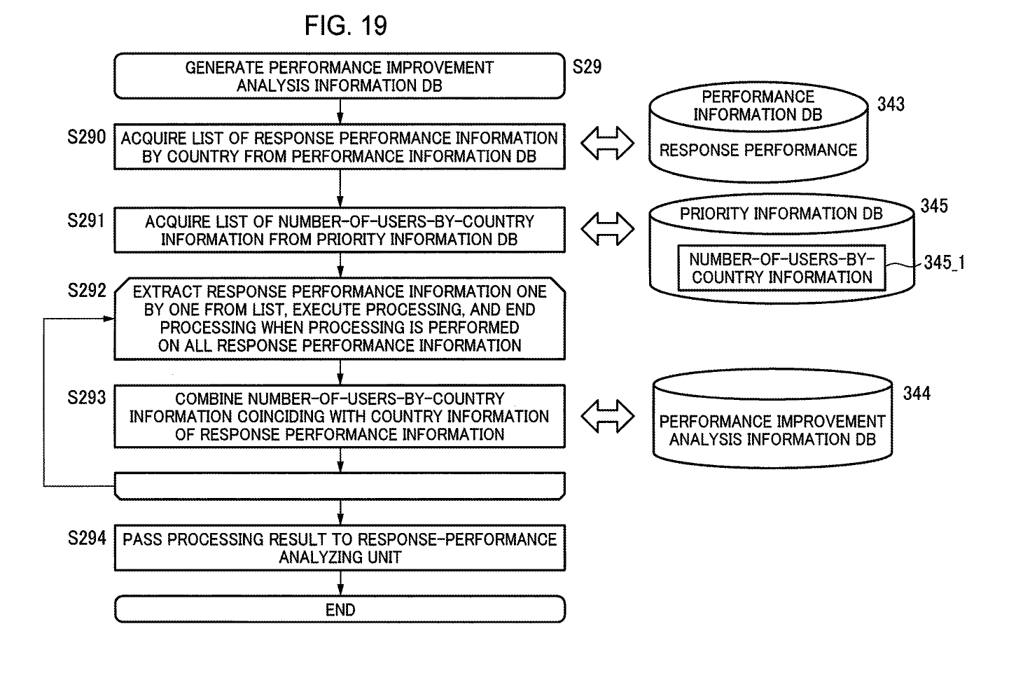

FIG. 19 is a detailed flowchart of the generation processing S29 for the performance-improvement-analysis-information database. The performance-improvement-analysis-information generating unit 342 acquires a list of response performance information by country from the performance information database (S290), acquires a list of number-of-user-by-country information from the priority information database 345 (S291), and registers all of the response performance information and the number-of-users-by-country information in the performance-improvement-analysis-information database in association with each other (S292 and S293). The performance-improvement-analysis-information generating unit 342 passes a processing result to the response-performance analyzing unit 341 (S294).

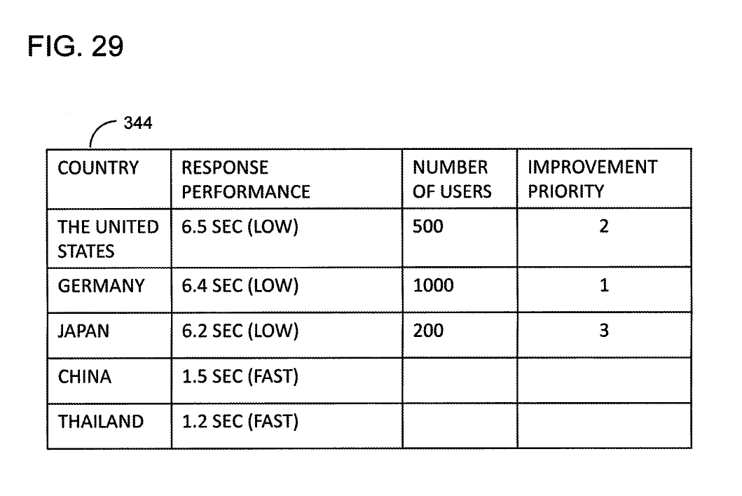

FIG. 29 is a diagram depicting an example of the performance improvement analysis information table. In a performance improvement analysis information table 244, a country, response performance, and the number of users are associated with one another. Improvement priority is determined in descending order of the numbers users in the United States, Germany, and Japan where the response performance is low to the same degree.

In the second embodiment, the response speed is explained as an example of the performance information and the number of users by country is explained as an example of the performance improvement priority. However, the performance information and the performance improvement priority are not limited to these examples.

For example, as an example of the performance improvement priority, instead of the number of users by country, the number of users by company or the number of users by connection point may be used. As an example of the performance information, instead of the response speed, resistance of a server during access concentration (e.g., the number of accesses processable per unit time) may be used.

As explained above, according to this embodiment, even if the management information corresponding to the priority of improvement of performance of the Web service in the service system involving the Web service and the configuration information of the job database of the service system are not acquired beforehand or the job database may be unable to be directly accessed, it is possible to acquire desired management information by analyzing a query and specifying a reporting target table, creating a query for acquiring priority information, and executing the acquisition query.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention. cm. What is claimed is:

1. A non-transitory computer-readable storage medium storing therein a management-information acquiring program that causes a computer to execute a process comprising:
acquiring queries to a target database for a management target service system;
specifying a reference target table in the database based on names of target tables included in the queries and content of the queries;
specifying a reporting target table on the basis of data of the reference target table;
causing the database to execute an acquisition query to the reporting target table; and
acquiring specific management information from the reporting target table.

2. The non-transitory computer-readable storage medium according to claim 1, wherein
the specifying the reporting target table includes specifying a plurality of the reporting target tables, and
the process further comprising:
creating the acquisition query on the basis of joining information of the plurality of reporting target tables included in an acquired query.

3. The non-transitory computer-readable storage medium according to claim 2, wherein,
the creating the acquisition query includes;
executing a joining information search function that makes a determination on whether joining information of a first table and a second table is included in the query and specifies the included joining information by using the reporting target tables as a function input, and
recursively executing the joining information search function until the joining information of the plurality of reporting target tables is obtained.

4. The non-transitory computer-readable storage medium according to claim 1, wherein,
the specifying the reference target table includes;
obtaining, for each of the target tables, a number of times when content of the queries is reference, a number of times when the content is registration, and a number of times when the content is update, and
specifying the target table as the reference target table when one or both of a condition under which the number of times of reference is larger than the number of times of registration and a condition under which the number of times of reference is larger than the number of times of update are satisfied.

5. The non-transitory computer-readable storage medium according to claim 1, wherein,
the specifying the reporting target table includes specifying the reference target table as the reporting target table when data of the reference target table includes data of the reporting target table.

6. A method of acquiring management-information, the method comprising:
acquiring queries to a target database for a management target service system;
specifying a reference target table included in the database based on names of target tables included in the queries and content of the queries;
specifying a reporting target table on the basis of data of the reference target table;
causing the database to execute an acquisition query to the reporting target table; and
acquiring specified management information from the reporting target table.

7. The method according to claim 1, wherein
the specifying the reporting target table includes specifying a plurality of the reporting target tables, and
the process further comprising:
creating the acquisition query on the basis of joining information of the plurality of reporting target tables included in an acquired query.

8. An apparatus that acquires acquiring management information, the apparatus comprising:
an install unit configured to install, in a management target system, a management-information acquiring program for causing a computer to execute a process including:
acquiring queries to a target database for a management target system,
specifying a reference target table included in the database based on names of target tables included in the queries and content of the queries,
specifying a reporting target table on the basis of data of the reference target table,
causing the database to execute an acquisition query to the reporting target table, and
acquiring specific management information from the reporting target table; and
a receiver that receives the specific management information.

9. The apparatus according to claim 8, wherein
the specifying the reporting target table includes specifying a plurality of the reporting target tables, and
the process further includes creating the acquisition query on the basis of joining information of the plurality of reporting target tables included in an acquired query.

10. The apparatus according to claim 8, wherein the management information is acquired by executing the management information acquiring program, without executing a query directly to the database.
